(19) United States
(12) Patent Application Publication
(10) Pub. No.: US 2026/0092813 A1
(43) Pub. Date: Apr. 2, 2026

(54) IMAGING LUMINANCE, CHROMATICITY, AND VIEWING ANGLE ANALYZER

(71) Applicant: Suzhou Fstar Scientific Instrument Company Limited, Suzhou (CN)

(72) Inventors: Rui LIAN, Suzhou (CN); Fei YAN, Suzhou (CN)

(73) Assignee: Suzhou Fstar Scientific Instrument Company Limited, Suzhou (CN)

(21) Appl. No.: 19/414,322

(22) Filed: Dec. 10, 2025

Related U.S. Application Data
(63) Continuation of application No. PCT/CN2025/071018, filed on Jan. 7, 2025.

(30) Foreign Application Priority Data
Mar. 14, 2024 (CN) 2024102898605

(51) Int. Cl. G01J 3/50; G01B 11/26; G01J 1/42; G01J 1/44; G01J 3/02

(52) U.S. Cl. CPC G01J 3/506; G01B 11/26; G01J 1/44; G01J 3/021; G01J 2001/4247

(57) ABSTRACT

An imaging luminance, chromaticity, and viewing angle analyzer is provided, belonging to the technical field of optical instrument manufacturing, and including a housing. A turntable is disposed on an upper surface of the housing, a CCD electronic lens and a conical lens are disposed throughout an off-center point of the turntable, a rangefinder is disposed at the center of the turntable, a spectrometer and an RGB camera are disposed inside the housing, a through hole cooperating with the RGB camera and the spectrometer is provided in the upper surface of the housing, a filter switching apparatus cooperating with the through hole is disposed inside the housing between the through hole and the RGB camera, and a turntable drive apparatus for driving the turntable is also disposed inside the housing.

### CROSS-REFERENCE TO RELATED APPLICATIONS

The application claims priority to Chinese patent application No. 2024102898605, filed on Mar. 14, 2024, the entire contents of which are incorporated herein by reference.

### TECHNICAL FIELD

The present disclosure belongs to the technical field of optical instrument manufacturing, and specifically an imaging luminance, chromaticity, and viewing angle analyzer.

### BACKGROUND

With the progress of the times and the development of technology, the display screen industry is developing faster and faster, and the demand is increasing. The requirements for the speed and ease of operation of product testing are getting higher and higher. Therefore, there is an urgent need to develop an instrument that can meet customer' needs for faster and more stable measurement of the optical characteristics such as spectrum, brightness, chromaticity, and viewing angle of the display screen.

### SUMMARY

An objective of the present disclosure is to address the shortcomings in the existing technology. An imaging luminance, chromaticity, and viewing angle analyzer is designed in a manner that a turntable drives a CCD (Charge Coupled Device) electronic lens and a conical lens to cooperate with a spectrometer and an RGB (Red, Green, Blue) camera, which solves the problem of how to test optical characteristics such as spectrum, brightness, chromaticity, and viewing angle of a display screen on a single testing device.

To achieve the above objective, the present disclosure adopts the technical solution:

An imaging luminance, chromaticity, and viewing angle analyzer, including a housing, a CCD electronic lens, a turntable, a conical lens, a spectrometer, an RGB camera, and a rangefinder, where the turntable is disposed on an upper surface of the housing, the CCD electronic lens and the conical lens are disposed throughout an off-center point of the turntable, a distance from the CCD electronic lens to the center of the turntable is equal to that from the conical lens to the center of the turntable, the rangefinder is disposed at the center of the turntable, the spectrometer and the RGB camera are disposed inside the housing, a through hole cooperating with the RGB camera and the spectrometer is provided in the upper surface of the housing, a distance from the through hole to a central axis of the turntable is equal to that from the CCD electronic lens to the central axis of the turntable, a filter switching apparatus cooperating with the through hole is disposed inside the housing between the through hole and the RGB camera, a turntable drive apparatus for driving the turntable is also disposed inside the housing.

Preferably, a reflector and a quartz optical fiber are also disposed in the housing, the RGB camera and the spectrometer are both fixedly disposed in the housing, a light inlet of the RGB camera faces the through hole and is located directly below the through hole, the spectrometer is located besides the RGB camera, the reflector is disposed on an inner top wall of the housing by a driver, a path of the driver driving the reflector is at least partially located directly below the through hole, the reflector is located above the filter switching apparatus, a light outlet of the quartz optical fiber is connected to the spectrometer, and when the reflector reflects a ray entering from the through hole, the ray reflected by the reflector enters the light inlet of the quartz optical fiber.

Preferably, the driver is a cylinder, a free end of a piston rod of the cylinder is fixedly connected to a mounting seat, and the reflector is disposed on the mounting seat.

Preferably, an included angle between a mirror surface of the reflector and an end face of the turntable is 45 degrees, an axis of the light inlet of the quartz optical fiber is parallel to the end face of the turntable, and when the reflector reflects the ray entering from the through hole, the light inlet of the quartz optical fiber faces a reflecting surface of the reflector.

Preferably, a photoelectric inductive probe is also disposed in the housing, and the light outlet of the quartz optical fiber is connected to the photoelectric inductive probe.

Preferably, the filter switching apparatus comprises a gear plate, filters, a first drive gear, and a first servo motor; the gear plate is rotatably disposed on an inner top wall of the housing, a rotation shaft of the gear plate is parallel to that of the turntable, a plurality of filters are uniformly arranged on the gear plate around the center of the gear plate, the first servo motor is disposed in the housing, the first drive gear is coaxially disposed on an output shaft of the first servo motor, the first drive gear meshes with the gear plate, a distance from edges of the filters facing the central axis of the gear plate to the central axis of the gear plate is less than that from the through hole to the central axis of the gear plate, and a distance from the edges of the filters facing away from the central axis of the gear plate to the central axis of the gear plate is greater than that from the through hole to the central axis of the gear plate.

Preferably, the turntable drive apparatus includes a second servo motor, a second drive gear, and a third drive gear; the turntable is coaxially provided with the third drive gear in the housing, the second servo motor is fixedly disposed in the housing, the second drive gear is coaxially and fixedly disposed on an output shaft of the second servo motor, and the second drive gear meshes with the third drive gear.

Preferably, the turntable drive apparatus and the filter switching apparatus are located on both sides of the central axis of the turntable.

Compared with the existing technology, the present disclosure has the following beneficial effects:
1. In the present disclosure, an imaging luminance, chromaticity, and viewing angle analyzer is designed in a manner that the turntable drives the CCD electronic lens and the conical lens to cooperate with the spectrometer and the RGB camera, which solves the problem of how to test optical characteristics such as spectrum, brightness, chromaticity, and viewing angle of a display screen on a single testing device.
2. In the present disclosure, the arrangement of the mounting seat facilitates the installation of the reflector, and the cylinder is mainly arranged to drive the reflector to move, such that when the spectrum needs to be measured, the reflector is located directly below the through hole and the ray passing through the through hole is reflected by the reflector to the light inlet of the quartz optical fiber. When the cylinder contracts, the reflector moves away from directly below the through hole, allowing the ray entering the through hole to be directly focused onto an image sensor of the RGB camera.
3. Since the axis of the CCD electronic lens and the axis of the conical lens are both perpendicular to the turntable, that is, the axis of the CCD electronic lens and the axis of the conical lens are both parallel to the axis of the through hole, in the present disclosure, the included angle between the mirror surface of the reflector and the end face of the turntable is designed as 45 degrees, and the axis of the light inlet of the quartz optical fiber is parallel to the end face of the turntable. Therefore, when the reflector reflects the ray entering from the through hole, the light inlet of the quartz optical fiber faces the reflecting surface of the reflector, thereby causing the ray passing through the through hole to be reflected by the reflector to the light inlet of the quartz optical fiber.

### BRIEF DESCRIPTION OF DRAWINGS

FIG. 1 is a schematic structural diagram of the present disclosure assembled into a single laboratory;

FIG. 2 is a schematic structural diagram of the present disclosure assembled into a plurality of laboratories combined together;

FIG. 3 is a schematic structural diagram after separating a main frame from a sub-frame in the present disclosure;

FIG. 4 is an enlarged view of portion A in FIG. 3;

FIG. 5 is a schematic diagram showing male and female plugs on a sub-frame;

FIG. 6 is an enlarged view of portion B in FIG. 5; and

FIG. 7 is a schematic structural diagram of a cross section of a first profile strip in the present disclosure.

Reference numerals: housing 1; CCD electronic lens 2; turntable 3; conical lens 4; spectrometer 5; RGB camera 6; rangefinder 7; through hole 8; reflector 9; quartz optical fiber 10; cylinder 11; mounting seat 12; photoelectric inductive probe 13; gear plate 14; filter 15; first drive gear 16; first servo motor 17; second servo motor 18; second drive gear 19; third drive gear 20.

### DETAILED DESCRIPTION OF THE EMBODIMENTS

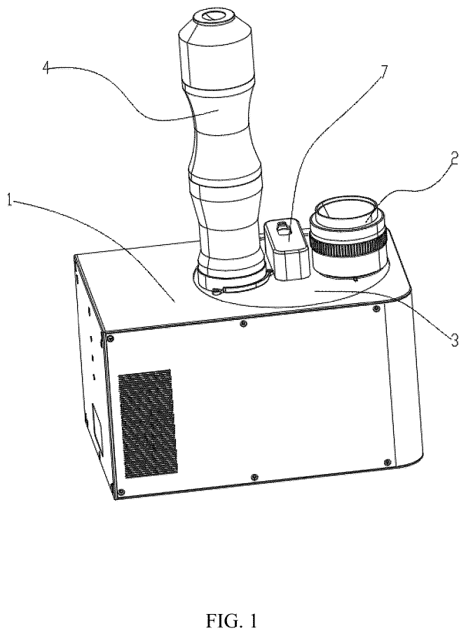

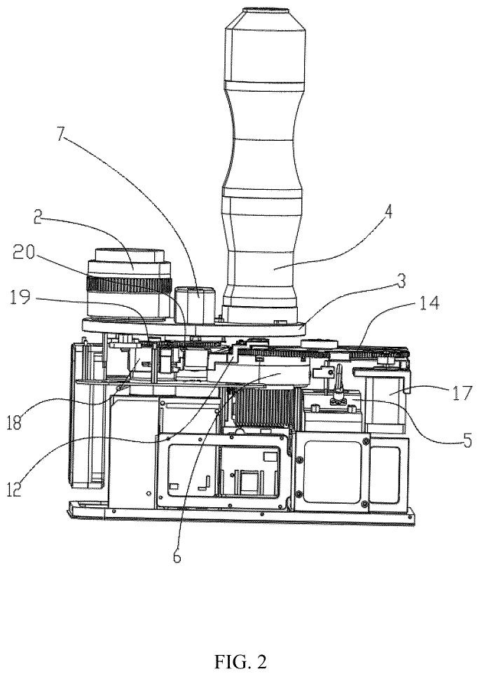

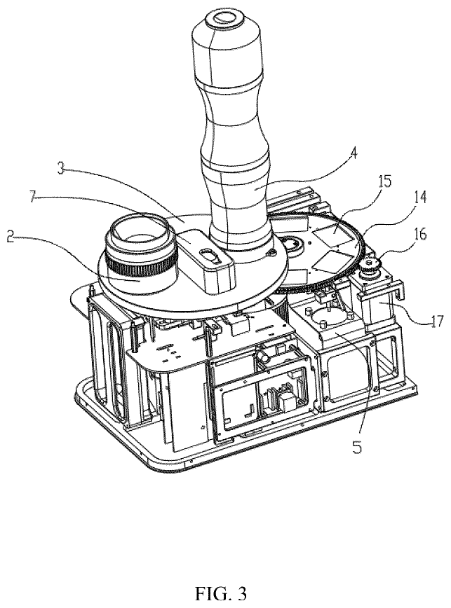

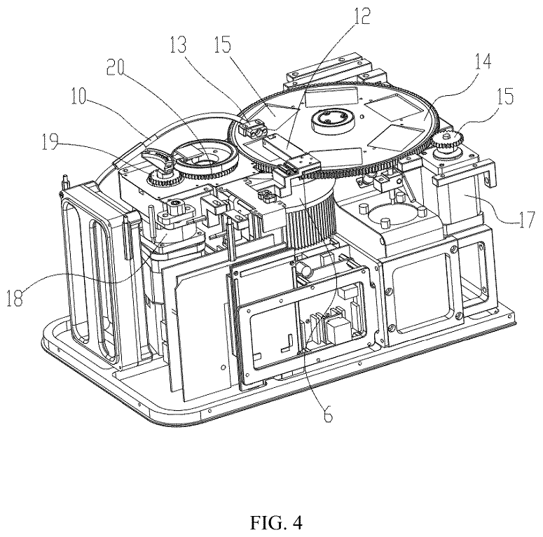

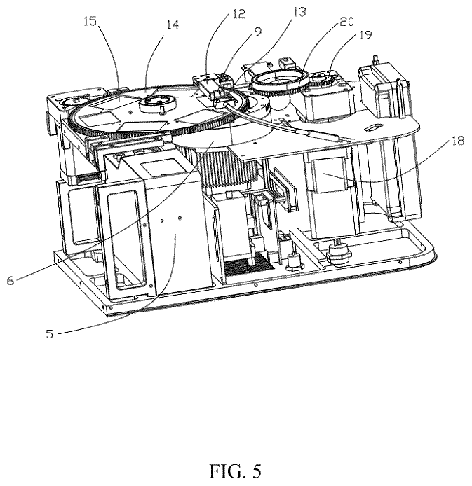

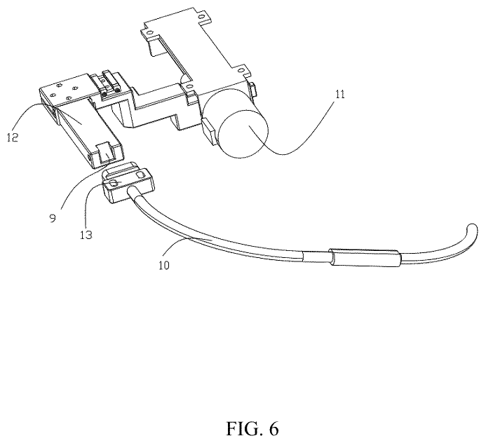

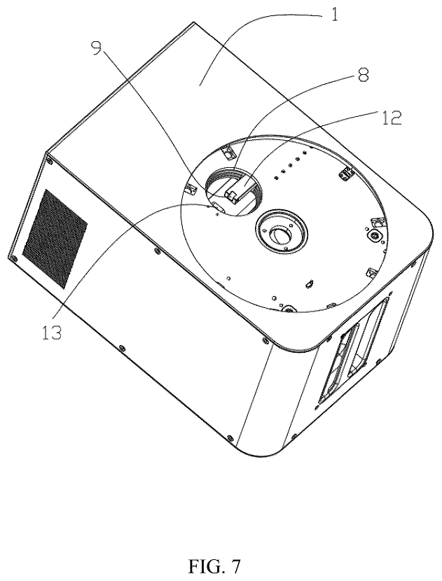

As shown in FIGS. 1-7, an imaging luminance, chromaticity, and viewing angle analyzer, including a housing 1, a CCD electronic lens 2, a turntable 3, a conical lens 4, a spectrometer 5, an RGB camera 6, and a rangefinder 7, where the turntable 3 is disposed on an upper surface of the housing 1, the CCD electronic lens 2 and the conical lens 4 are disposed throughout an off-center point of the turntable 3, a distance from the CCD electronic lens 2 to the center of the turntable 3 is equal to that from the conical lens 4 to the center of the turntable 3, the rangefinder 7 is disposed at the center of the turntable 3, the spectrometer 5 and the RGB camera 6 are disposed inside the housing 1, a through hole 8 cooperating with the RGB camera 6 and the spectrometer 5 is provided in the upper surface of the housing 1, a distance from the through hole 8 to a central axis of the turntable 3 is equal to that from the CCD electronic lens 2 to the central axis of the turntable 3, a filter switching apparatus cooperating with the through hole 8 is disposed inside the housing 1 between the through hole 8 and the RGB camera 6, a turntable drive apparatus for driving the turntable 3 is also disposed inside the housing 1, a reflector 9 and a quartz optical fiber 10 are also disposed in the housing 1, the RGB camera 6 and the spectrometer 5 are both fixedly disposed in the housing 1, a light inlet of the RGB camera 6 faces the through hole 8 and is located directly below the through hole 8, the spectrometer 5 is located besides the RGB camera 6, the reflector 9 is disposed on an inner top wall of the housing 1 by a driver, a path of the driver driving the reflector 9 is at least partially located directly below the through hole 8, the reflector 9 is located above the filter switching apparatus, a light outlet of the quartz optical fiber 10 is connected to the spectrometer 5, and when the reflector 9 reflects a ray entering from the through hole 8, the ray reflected by the reflector 9 enters the light inlet of the quartz optical fiber 10.

In this embodiment, when in use, the rangefinder 7 is configured to measure the distance from the object being measured (the display) to the CCD electronic lens 2 and the distance from the object being measured to the conical lens 4 (more precisely, the distance from the display to the upper surface of the housing 1, since the lengths of the CCD electronic lens 2 and the conical lens 4 are fixed, the distance from the display to the CCD electronic lens 2 and the distance from the display to the conical lens 4 are indirectly measured). When multi-view measurement of the object is required, the turntable drive apparatus drives the turntable 3 to rotate, such that the conical lens 4 is located directly above the through hole 8. At this time, the conical lens 4 cooperates with the RGB camera 6 to perform multi-view measurement on the object being measured. When it is necessary to measure the spectrum, brightness, chromaticity, uniformity, grayscale response time, and Flicker of the object being measured, the turntable drive apparatus drives the turntable 3 to rotate, such that the CCD electronic lens 2 is located directly above the through hole 8. At this time, the CCD electronic lens 2 focuses the image formed directly on the image sensor of the RGB camera 6. When the driver drives the reflector 9 to be directly below the through hole 8, the reflector 9 reflects and focuses the image formed by the CCD electronic lens 2 onto the light inlet of the quartz optical fiber 10. The quartz optical fiber 10 then transmits the image formed by the CCD electronic lens 2 to the spectrometer 5 for spectrum measurement. The filter switching apparatus is mainly for matching the field of view to the CIE standard observer color matching function, thus allowing the use of a single device to test the optical characteristics such as spectrum, brightness, chromaticity, and viewing angle of the display screen, making product testing faster and easier to operate.

In a preferred embodiment, the driver is a cylinder 11, a free end of a piston rod of the cylinder 11 is fixedly connected to a mounting seat 12, and the reflector 9 is disposed on the mounting seat 12. The arrangement of the mounting seat 12 facilitates the installation of the reflector 9, and the cylinder 11 is mainly arranged to drive the reflector 9 to move, such that when the spectrum needs to be measured, the reflector 9 is located directly below the through hole 8 and the ray passing through the through hole 8 is reflected by the reflector 9 to the light inlet of the quartz optical fiber 10. When the cylinder 11 contracts, the reflector 9 moves away from directly below the through hole 8, allowing the ray entering the through hole 8 to be directly focused onto an image sensor of the RGB camera 6.

As a preferred embodiment, since the axis of the CCD electronic lens 2 and the axis of the conical lens 4 are both perpendicular to the turntable 3, that is, the axis of the CCD electronic lens 2 and the axis of the conical lens 4 are both parallel to the axis of the through hole 8, the included angle between the mirror surface of the reflector 9 and the end face of the turntable 3 is designed as 45 degrees, and the axis of the light inlet of the quartz optical fiber 10 is parallel to the end face of the turntable 3. Therefore, when the reflector 9 reflects the ray entering from the through hole 8, the light inlet of the quartz optical fiber 10 faces the reflecting surface of the reflector 9, thereby causing the ray passing through the through hole 8 to be reflected by the reflector 9 to the light inlet of the quartz optical fiber 10.

As a preferred embodiment, a photoelectric inductive probe 13 is also disposed in the housing 1, and the light outlet of the quartz optical fiber 10 is connected to the photoelectric inductive probe 13. The photoelectric inductive probe 13 is configured to receive the image formed by the CCD electronic lens 2.

In a preferred embodiment, the filter switching apparatus includes a gear plate 14, filters 15, a first drive gear 16, and a first servo motor 17. The gear plate 14 is rotatably disposed on an inner top wall of the housing 1, a rotation shaft of the gear plate 14 is parallel to that of the turntable 3, a plurality of filters 15 are uniformly arranged on the gear plate 14 around the center of the gear plate 14, the first servo motor 17 is disposed in the housing 1, the first drive gear 16 is coaxially disposed on an output shaft of the first servo motor 17, the first drive gear 16 meshes with the gear plate 14, a distance from edges of the filters 15 facing the central axis of the gear plate 14 to the central axis of the gear plate 14 is less than that from the through hole 8 to the central axis of the gear plate 14, and a distance from the edges of the filters 15 facing away from the central axis of the gear plate 14 to the central axis of the gear plate 14 is greater than that from the through hole 8 to the central axis of the gear plate 14.

With this arrangement, the first servo motor 17 drives the gear plate 14 to rotate, thereby enabling different filters 15 to be replaced as needed. The arrangement that “a distance from edges of the filters 15 facing the central axis of the gear plate 14 to the central axis of the gear plate 14 is less than that from the through hole 8 to the central axis of the gear plate 14, and a distance from the edges of the filters 15 facing away from the central axis of the gear plate 14 to the central axis of the gear plate 14 is greater than that from the through hole 8 to the central axis of the gear plate 14” ensures that the rotation of the gear plate 14 can adjust the filters 15 to be located directly below the through hole 8.

In a preferred embodiment, the turntable drive apparatus includes a second servo motor 18, a second drive gear 19, and a third drive gear 20. The turntable 3 is coaxially provided with the third drive gear 20 in the housing 1, the second servo motor 18 is fixedly disposed in the housing 1, the second drive gear 19 is coaxially and fixedly disposed on an output shaft of the second servo motor 18, and the second drive gear 19 meshes with the third drive gear 20. The second drive gear 19 meshes with the third drive gear 20. In this way, the rotation of the turntable can be adjusted by the second servo motor 18, thereby achieving the switching between the CCD electronic lens 2 and the conical lens 4.

As a preferred embodiment, the turntable drive apparatus and the filter switching apparatus are located on both sides of the central axis of the turntable 3, which can improve the utilization of the space inside the housing 1.

What is claimed is:

1. An imaging luminance, chromaticity, and viewing angle analyzer, comprising a housing (1), a CCD electronic lens (2), a turntable (3), a conical lens (4), a spectrometer (5), an RGB camera (6), and a rangefinder (7), wherein the turntable (3) is disposed on an upper surface of the housing (1), the CCD electronic lens (2) and the conical lens (4) are disposed throughout an off-center point of the turntable (3), a distance from the CCD electronic lens (2) to the center of the turntable (3) is equal to that from the conical lens (4) to the center of the turntable (3), the rangefinder (7) is disposed at the center of the turntable (3), the spectrometer (5) and the RGB camera (6) are disposed inside the housing (1), a through hole (8) cooperating with the RGB camera (6) and the spectrometer (5) is provided in the upper surface of the housing (1), a distance from the through hole (8) to a central axis of the turntable (3) is equal to that from the CCD electronic lens (2) to the central axis of the turntable (3), a filter switching apparatus cooperating with the through hole (8) is disposed inside the housing (1) between the RGB camera (6) and the through hole (8), a turntable drive apparatus for driving the turntable (3) is also disposed inside the housing (1), a reflector (9) and a quartz optical fiber (10) are also disposed in the housing (1), the RGB camera (6) and the spectrometer (5) are both fixedly disposed in the housing (1), a light inlet of the RGB camera (6) faces the through hole (8) and is located directly below the through hole (8), the spectrometer (5) is located besides the RGB camera (6), the reflector (9) is disposed on an inner top wall of the housing (1) by a driver, a path of the driver driving the reflector (9) is at least partially located directly below the through hole (8), the reflector (9) is located above the filter switching apparatus, a light outlet of the quartz optical fiber (10) is connected to the spectrometer (5), and when the reflector (9) reflects a ray entering from the through hole (8), the ray reflected by the reflector (9) enters the light inlet of the quartz optical fiber (10).

2. The imaging luminance, chromaticity, and viewing angle analyzer according to claim 1, wherein the driver is a cylinder (11), a free end of a piston rod of the cylinder (11) is fixedly connected to a mounting seat (12), and the reflector (9) is disposed on the mounting seat (12).

3. The imaging luminance, chromaticity, and viewing angle analyzer according to claim 1, wherein an included angle between a mirror surface of the reflector (9) and an end face of the turntable (3) is 45 degrees, an axis of the light inlet of the quartz optical fiber (10) is parallel to the end face of the turntable (3), and when the reflector (9) reflects the ray entering from the through hole (8), the light inlet of the quartz optical fiber (10) faces a reflecting surface of the reflector (9).

4. The imaging luminance, chromaticity, and viewing angle analyzer according to claim 1, wherein a photoelectric inductive probe (13) is also disposed in the housing (1), and the light outlet of the quartz optical fiber (10) is connected to the photoelectric inductive probe (13).

5. The imaging luminance, chromaticity, and viewing angle analyzer according to claim 1, wherein the filter switching apparatus comprises a gear plate (14), filters (15), a first drive gear (16), and a first servo motor (17); the gear plate (14) is rotatably disposed on an inner top wall of the housing (1), a rotation shaft of the gear plate (14) is parallel to that of the turntable (3), a plurality of filters (15) are uniformly arranged on the gear plate (14) around the center of the gear plate (14), the first servo motor (17) is disposed in the housing (1), the first drive gear (16) is coaxially disposed on an output shaft of the first servo motor (17), the first drive gear (16) meshes with the gear plate (14), a distance from edges of the filters (15) facing the central axis of the gear plate (14) to the central axis of the gear plate (14) is less than that from the through hole (8) to the central axis of the gear plate (14), and a distance from the edges of the filters (15) facing away from the central axis of the gear plate (14) to the central axis of the gear plate (14) is greater than that from the through hole (8) to the central axis of the gear plate (14).

6. The imaging luminance, chromaticity, and viewing angle analyzer according to claim 1, wherein the turntable drive apparatus comprises a second servo motor (18), a second drive gear (19), and a third drive gear (20); the turntable (3) is coaxially provided with the third drive gear (20) in the housing (1), the second servo motor (18) is fixedly disposed in the housing (1), the second drive gear (19) is coaxially and fixedly disposed on an output shaft of the second servo motor (18), and the second drive gear (19) meshes with the third drive gear (20).

7. The imaging luminance, chromaticity, and viewing angle analyzer according to claim 1, wherein the turntable drive apparatus and the filter switching apparatus are located on both sides of the central axis of the turntable (3).
